(19) United States
(12) Patent Application Publication
(10) Pub. No.: US 2006/0086214 A1
(43) Pub. Date: Apr. 27, 2006

(54) Security screw

(76) Inventor: Ole Falk Smed, Palm Desert, CA (US)

Correspondence Address: John B. Hardaway, III;NEXSEN PRUET, LLC, Fed. Sta., P.O. Box 10107, Greenville, SC, 29603-0107, US

(21) Appl. No.: 10/973,647

(22) Filed: Oct. 26, 2004

(51) Int. Cl. B25B 13/48; B25B 23/00; B25B 13/56

(52) U.S. Cl. 81/461; 81/176.15

(57) ABSTRACT

A security head for a screw or bolt has three blind bores in the top of the head. The head can be turned only by using a special drive bit which is not available to unauthorized parties.

### FIELD OF THE INVENTION

The invention relates to screw and bolt heads which are tamper resistant to prevent unauthorized removal of screws or bolts.

### BACKGROUND AND PRIOR ART

Screws and bolts which cannot be removed using standard spanner wrenches and flat blade, Phillips and hexkey drivers have become a modern necessity to prevent theft, vandalism and access to electrical and electronic components.

U.S. Pat. No. 4,411,570 to Juric, U.S. Pat. No. 5,598,753 to Lee, and U.S. Pat. No. 6,341,927 to Hampson et al. are representative of many designs to prevent tampering with threaded fasteners. All such tamper-proof screws and bolt heads use some type of “security bit” which is usually an odd design intended to act like a key in a lock. Most screw and bolt heads for tamper-proofing are low profile with rounded or beveled sides so that standard pliers and other gripping devices slide off when squeezed. In the absence of the correct security drive bit, the screw or bolt cannot be removed without drilling or chiseling. Most security bits, however, are available in many hardware and auto parts stores, meaning that most such screws and bolts are only vandal proof.

### BRIEF SUMMARY OF THE INVENTION

It is a first objective of this invention to provide a screw or bolt head which cannot be removed using a gripping tool. It is a second objective of this invention to provide a screw or bolt head which requires a unique driver to remove said screw. These and other objectives may be obtained by using a screw or bolt head having three tubular depressions (blind bores) formed within a flat head, each positioned equidistant from the other and center of the screw shaft.

### BRIEF DESCRIPTION OF THE DRAWINGS

FIG. 1 is a side elevation of a tamper-proof screw according to the invention.

FIG. 2 is a plan view of the head of a screw or bolt according to this invention.

FIG. 3 is a perspective view of a tamper-proof bit according to the invention.

### DETAILED DESCRIPTION OF THE INVENTION

The invention is a tamper-proof screw or bolt having a unique design for which no driver bit is commercially available. The head may be flat and beveled toward the threads so that it can be countersunk into the surface of the fastened object or other low profile head which cannot be held and turned by a spanner, pliers, or other readily available tool.

The head of the screw or bolt (hereinafter fastener) has three blind bores into which a driving bit fits. The holes are centered approximately over the shaft circle although the bore centers vary somewhat with fastener size. The bores in a first embodiment are spaced at 120° but may be varied to create unique combinations so long as the load during tightening is equal on both sides of at least one diameter.

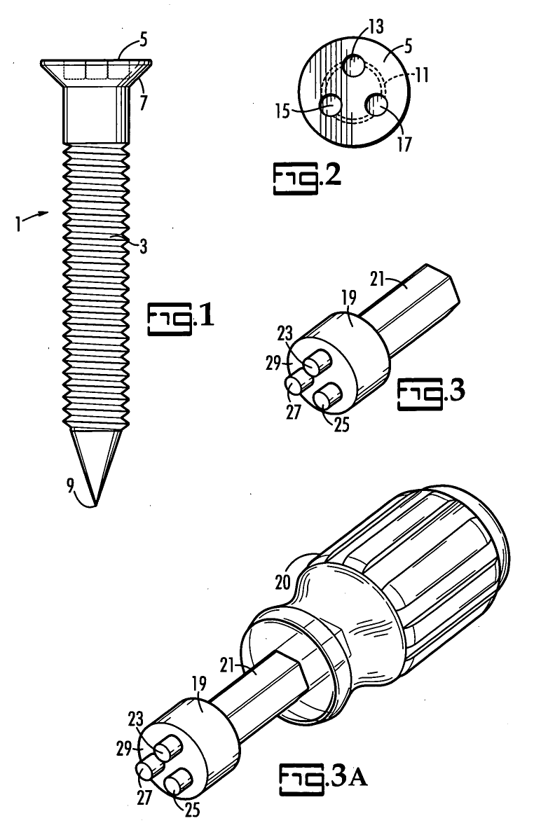

FIG. 1 is a side elevation of a fastener (in this embodiment a screw) according to a first embodiment of the invention.

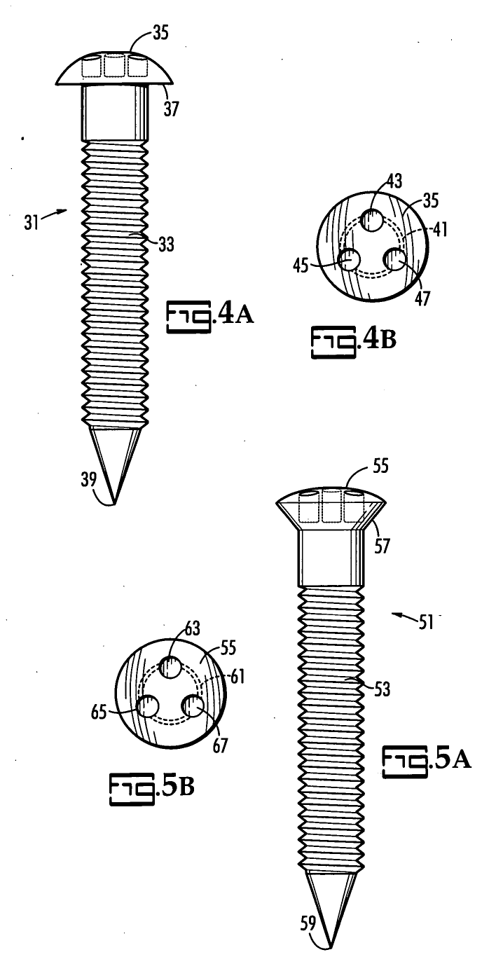

Fastener 1 has a threaded shaft 3 and a flat head 5. The head is beveled at 7 to taper to the shaft 3. When the embodiment is a screw, the shaft comes to a point 9. FIG. 2 is a plan view of a fastener head according to a first embodiment of the invention. Head 5, in this case a flat head, has blind bores 13, 15 and 17 with centers approximately over the shaft circle of the fastener, as indicated by 11,

The blind bores preferably are tubular bores although other geometric shapes such as squares are feasible and offer even greater security.

FIG. 3 is a security bit key for use with the security head. The key 19 has a shaft 21 for connection to a driver. The driver may be a hex nut driver socket or the shaft of a unitary driver having a grip (e.g. nut driver). Three prongs, 23, 25 and 27 project from a flat face 29.

In the first embodiment, the bores 13, 15 and 17 and the prongs 23, 25, and 27 are arranged at 120°, equally around the fastener. For added security, the spacing may be changed so long as the center of force when being turned using the bit is on a diameter which passes across the origin of the head.

The fastener and security by combination is vandal-proof because the key is not available in conventional hardware stores. Additional security can be obtained by restricting access to the security key to large purchasers or users of the fasteners. Use of a left handed thread is another security option.

In a second embodiment, instead of a flat head fastener a low profile raised head may be used, such as in a truss or oval screw. The security bit may be modified from that shown in FIG. 3 so that the flat face 29 becomes concave to match the convexity of the fastener head.

### INDUSTRIAL UTILITY

The security fastener according to this invention may be used to tamper-proof access hatches, equipment covers, cellular floor panels, and other areas where access is undesirable for unauthorized personnel and to vandal-proof outdoor fixtures accessible to the general public. Maximum security is obtained by selling the driver bit to only authorized persons.

This invention has been described in terms of illustrative examples which are not limitations to the scope of the invention. Modifications and variations apparent to those with skill in the art are subsumed within the spirit and scope of the invention.

1. A head for a fastener having three blind bores distributed in a circle around the axis of origin of the fastener.

2. A head for a fastener according to claim 1 wherein the blind bores are distributed at 120° on the circle.

3. A head for a fastener according to claim 1 wherein the blind bores are distributed at different angles with the proviso that a line bisecting a line between two bores crosses the axis of origin of the circle and passes through the third bore.

4. A head for a fastener having three blind bores distributed in a circle.

5. A head for a fastener according to claim 4 wherein said blind bores are in the form of a regular geometric figure.

6. A head for a fastener according to claim 1 which is a flat head.

7. A head for a fastener according to claim 1 which is an oval head.

8. A head for a fastener according to claim 1 which is a truss head.

9. A drive bit for a fastener having three prongs symmetrically distributed on the face of a flat drive surface.

10. A drive bit according to claim 9 wherein said prongs are tubular.

11. A drive bit according to claim 9 wherein said prongs are distributed at 120° angles on a circle from the axis of origin of the bit.

12. A drive bit according to claim 9 having a shaft insertable into a driver head.

13. A drive bit according to claim 9 having a shaft integrally connected to a grip.

14. A kit comprising a fastener having a head wherein three blind bores are distributed in a circle around the axis of origin of the fastener and a drive bit for said fastener having three prongs on a flat face, said prongs distributed in a circle around the origin axis of the drive bit, said prongs being insertable into said blind bores.

15. A drive bit for a fastener having three prongs symmetrically distributed on the face of a concave drive surface.
